(19) United States
(12) Patent Application Publication
(10) Pub. No.: US 2010/0095286 A1
(43) Pub. Date: Apr. 15, 2010

(54) REGISTER REDUCTION AND LIVENESS ANALYSIS TECHNIQUES FOR PROGRAM CODE

(76) Inventor: David A. Kaplan, Austin, TX (US)

Correspondence Address: MEYERTONS, HOOD, KIVLIN, KOWERT & GOETZEL (AMD), P.O. BOX 398, AUSTIN, TX, 78767-0398, US

(21) Appl. No.: 12/249,446

(22) Filed: Oct. 10, 2008

(51) Int. Cl. G06F 9/45

(52) U.S. Cl. 717/156; 717/154

(57) ABSTRACT

A system and method for efficient architectural register liveness analysis and register usage reduction. A compiler within a computing system maintains a master liveness vector for each instruction in a program code and a path liveness vector for each path within a predetermined control flow graph (CFG). Predetermined required paths from an earlier compiler stage are used to find force paths, which are used to reduce the number of times a control block (CB) is processed. Upon completion of the liveness analysis, the compiler finds an instruction within the program code where a chosen register previously dead is now live. The compiler identifies allocation code paths from this instruction, wherein each path terminates at an instruction wherein the chosen register is dead for the first time in the allocation code path. The compiler subsequently replaces the chosen register with a determined dead register.

### BACKGROUND OF THE INVENTION

1. Field of the Invention

This invention relates to high performance computing systems, and more particularly, to maintaining efficient architectural register context sensitive liveness analysis and usage reduction.

2. Description of the Relevant Art

When software programmers write applications to perform work according to an algorithm or a method, the programmers may utilize variables to reference temporary and result data. For example, architectural registers of an instruction set architecture (ISA) are used to store the temporary and result data. Architectural register usage elimination may be used when code uses more registers than an ISA contains and the code is ported to this machine, or to relieve register pressure. Register liveness analysis is performed in order to determine available registers to replace a chosen register in the code. Liveness analysis is a technique that determines when variables will be used in the future. In the case of binary code, liveness analysis determines which architectural registers hold values, which affect the outcome of the program.

A register X is referred to as “live” at an instruction Y if and only if there is a valid path from instruction Y to another instruction that reads X without any intervening writes to X. A register X is referred to as “dead” if no such path exists. For example, consider the following piece of pseudo-assembly code:

| | | |
|---|---|---|
| mov r5, r1 | # r1 ← r5 | /* line 1 */ |
| add r2, r3, r5 | # r2 ← r3 + r5 | |
| exit | | /* line 3 */ |

In the above code between the mov and the add instructions, the value of r5 is considered live since it is used in the add operation. The register r3 is also live at this point because it is read as part of the add operation as well. The other registers are considered dead since their values are not used and they do not affect the code execution as the code terminates after the add operation. Register liveness information is a representation, such as a bit vector or other, that indicates whether a particular architectural register is live or dead.

Liveness analysis has traditionally been used within optimizing compilers that perform register allocation. If a register is determined to be dead, this register does not need its value retained. Therefore, this register is a candidate for replacing another register in a predetermined block of code. Liveness analysis algorithms are needed in order to reduce the size of the architectural register file in use by code. However, some code may present issues for these liveness analysis algorithms.

For example, generic binary code, or microcode, comprises the lowest-level instructions that directly control a microprocessor. Microcode implements the instruction set of a processor as a sequence of microcode instructions (“microinstructions”), each of which typically consists of a large number of bit fields and the address of the next microinstruction to execute. Each bit field controls some specific part of the processor's operation, such as a gate, which allows some functional unit to drive a value onto a bus, to determine the next arithmetic logic unit (ALU) operation to perform, or other. Several microinstructions will usually be required to fetch, decode, and execute each machine code instruction, or macroinstruction. The microcode may also be responsible for polling for hardware interrupts between each macroinstruction. Typically microcode is stored in read-only memory (ROM) chips though some processors utilize fast random-access memory (RAM), making them dynamically microprogrammable.

Microcode may not follow high-level language conventions. When code is written in a high-level language, function call conventions greatly simplify the liveness analysis. Compilers do not need to propagate an algorithm into any functions that are called during program execution since the registers that are used in the function are well defined. Generic binary code, however, does not follow these conventions, and, thus, these assumptions cannot be made. Since binary code does not follow high-level conventions, issues are presented for liveness analysis algorithms and the accuracy of the generated data is reduced.

For example, due to the increased complexity of not having predetermined liveness information for function calls, false paths may not be removed during liveness analysis. False paths have the potential to contaminate resulting liveness data and now this data is useless for other applications such as architectural register usage reduction. One manner by which false paths originate is due to poor context sensitivity. Context sensitivity refers to determining where in a program an algorithm is currently located and from where within the program did the algorithm came from. Good context sensitivity helps eliminate false paths. One solution for eliminating false paths includes duplicating variables and increasing pointer control logic complexity in order to create separate distinct paths with duplicate sections. Some of those sections are the same due to these sections were previously shared by two or more paths. However, this approach is memory intensive.

Also, traditional liveness analysis algorithms may process all inflows for each section of a program code, wherein some of these inflows may be recursive calls or offer no new information. The result may be a slightly different path at the bottom of a control flow graph generated by a compiler, and this slightly different path may not generate any new liveness information, but the traditional algorithm still propagates through the entire tree, or graph, consuming unproductive processor cycles.

In view of the above, efficient methods and mechanisms for maintaining efficient architectural register context sensitive liveness analysis and usage reduction is desired.

### SUMMARY OF THE INVENTION

Systems and methods for efficient architectural register context sensitive liveness analysis and register usage reduction are contemplated.

In one embodiment, an indication of the liveness of architectural registers is represented by a bit vector, wherein the bit vector has a corresponding bit for each register. A bit vector, or master liveness vector (MLV), is maintained for each instruction in program code. Rather than maintain two liveness vectors (LVs) for each instruction to compensate for inadvertent analysis of false paths that may lead to inaccurate liveness information, a single propagated path liveness vector (PLV) is utilized. A method is provided that utilized information regarding control blocks (CBs) and a control flow graph (CFG) from a prior compiler stage. For example, predetermined required paths are used to define force paths, wherein a force path is a list that contains all the CBs that may need to be visited after processing the current CB. Then only a specified CB should be subsequently processed, and not all the inflows to the current CB.

For a particular CB being processed, the method recognizes when a register is saved to and restored from memory in an attempt to ease register use pressure. However, such a case may lead to incorrect liveness information, which is recognized and corrected by the method. Another list is maintained of CBs being processed in order to reduce repeat processing due to recursive calls within a CB. This list is also used to determine whether the current stage of the path within the CFG is a required path with a corresponding force path.

A second single liveness vector, a result liveness vector (RLV), is maintained upon completion of the liveness analysis in order to determine which registers may be replaced by any existing dead registers. This analysis begins by finding a first instruction within the program code where a chosen register previously dead is now live. The method identifies allocation code paths from the first instruction, wherein each allocation code path terminates at an instruction wherein the chosen register is determined to be dead for the first time in the allocation code path. The method determines one or more registers may be dead within an accumulative traversal of these allocation code paths, and subsequently replaces the chosen register with a determined dead register.

In another embodiment, a compiler within a computing system is configured to perform register liveness analysis and register usage reduction on program code located on a memory coupled to one or more processors. The compiler uses control blocks and a control flow graph from a prior stage of compiling in order to optimize the program code as described above regarding the method.

In yet another embodiment, a computer readable storage medium stores program instructions operable to perform the above described embodiments, including register liveness analysis and reduce register usage. The program instructions are executable to optimize program code that may be stored on the same or a different computer readable storage medium utilizing the above described steps.

These and other embodiments are contemplated and will be appreciated upon reference to the following description and figures.

### BRIEF DESCRIPTION OF THE DRAWINGS

FIG. 1 is a generalized block diagram illustrating one embodiment of an exemplary processing subsystem.

FIG. 2 is a generalized block diagram illustrating one embodiment of a static compiler method.

FIG. 3A is a generalized block diagram of one embodiment of a control flow graph.

FIG. 3B is a generalized block diagram of one embodiment of a control flow graph.

FIG. 4 is a flow diagram of one embodiment of a method for register liveness analysis and register usage reduction.

FIG. 5 is a flow diagram of one embodiment of a method for determining architectural register liveness within a control block.

FIG. 6A is a flow diagram of one embodiment of a method for determining and eliminating dead registers from program code.

FIG. 6B is a flow diagram of one embodiment of a method for determining and eliminating dead registers from program code.

FIG. 6C is a flow diagram of one embodiment of a method for determining and eliminating dead registers from program code.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known circuits, structures, and techniques have not been shown in detail to avoid obscuring the present invention.

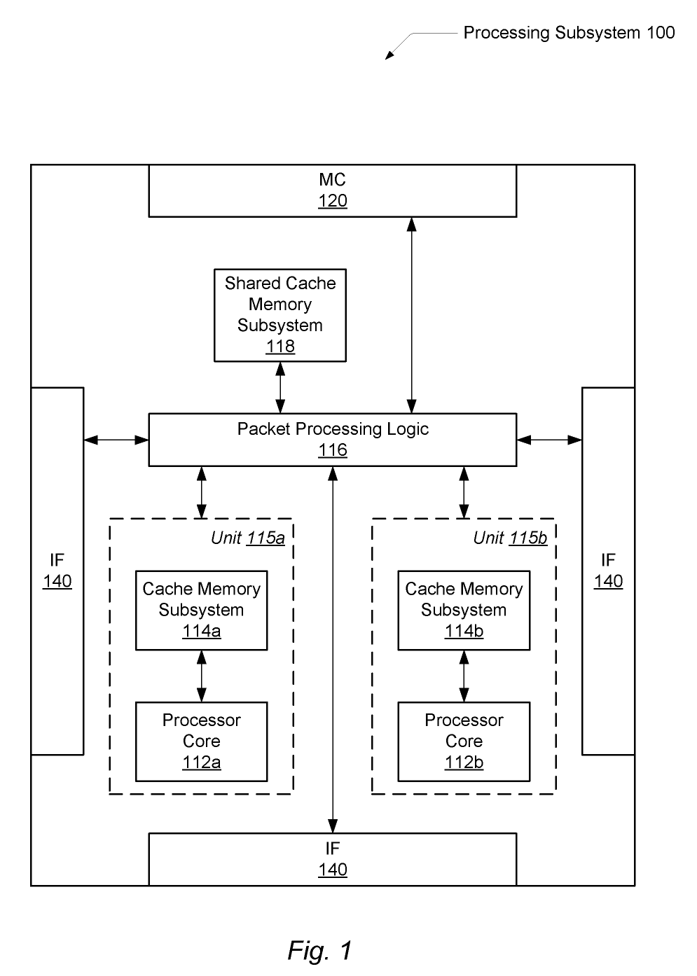

FIG. 1 is a block diagram of one embodiment of an exemplary processing subsystem 100. Processing subsystem 100 may include memory controller 120, interface logic 140, one or more processing units 115, which may include one or more processor cores 112 and a corresponding cache memory subsystems 114; packet processing logic 116, and a shared cache memory subsystem 118. Processing subsystem 100 may be a node within a multi-node computing system. In one embodiment, the illustrated functionality of processing subsystem 100 is incorporated upon a single integrated circuit.

Processing subsystem 100 may be coupled to a respective memory via a respective memory controller 120. The memory may comprise any suitable memory devices. For example, the memory may comprise one or more RAMBUS dynamic random access memories (DRAMs), synchronous DRAMs (SDRAMs), DRAM, static RAM, etc. Processing subsystem 100 and its memory may have its own address space from other nodes. Processing subsystem 100 may include a memory map used to determine which addresses are mapped to its memory. In one embodiment, the coherency point for an address within processing subsystem 100 is the memory controller 120 coupled to the memory storing bytes corresponding to the address. Memory controller 120 may comprise control circuitry for interfacing to memory. Additionally, memory controllers 120 may include request queues for queuing memory requests.

Outside memory may store microcode instructions. Microcode may allow much of the processor's behavior and programming model be defined via microprogram routines rather than by dedicated circuitry. Even late in a design process, microcode could easily be changed, whereas hard-wired circuitry designs are cumbersome to change. A processor's microprograms operate on a more hardware-oriented architecture than the assembly instructions visible to programmers. In coordination with the hardware, the microcode implements the programmer-visible architecture. The underlying hardware does not need to have a fixed relationship to the visible architecture, thus, allowing it to be possible to implement a given instruction set architecture (ISA) on a wide variety of underlying hardware micro-architectures. Microprogramming may also reduce the cost of changes to a processor, such as correcting defects, or bugs, in the already-released product. A defect may be fixed by replacing a portion of the microprogram rather than by making changes to hardware logic and wiring.

One or more processing units 115a-115b may include the circuitry for executing instructions of a program, such as a microprogram. As used herein, elements referred to by a reference numeral followed by a letter may be collectively referred to by the numeral alone. For example, processing units 115a-115b may be collectively referred to as processing units 115. Within processing units 115, processor cores 112 include circuitry for executing instructions according to a predefined general-purpose instruction set. For example, the x86 instruction set architecture may be selected. Alternatively, the Alpha, PowerPC, or any other general-purpose instruction set architecture may be selected. Generally, processor core 112 accesses the cache memory subsystems 114, respectively, for data and instructions.

Cache subsystems 114 and 118 may comprise high speed cache memories configured to store blocks of data. Cache memory subsystems 114 may be integrated within respective processor cores 112. Alternatively, cache memory subsystems 114 may be coupled to processor cores 114 in a backside cache configuration or an inline configuration, as desired. Still further, cache memory subsystems 114 may be implemented as a hierarchy of caches. Caches which are nearer processor cores 112 (within the hierarchy) may be integrated into processor cores 112, if desired. In one embodiment, cache memory subsystems 114 each represent L2 cache structures, and shared cache subsystem 118 represents an L3 cache structure.

Both the cache memory subsystem 114 and the shared cache memory subsystem 118 may include a cache memory coupled to a corresponding cache controller. If the requested block is not found in cache memory subsystem 114 or in shared cache memory subsystem 118, then a read request may be generated and transmitted to the memory controller within the node to which the missing block is mapped.

Generally, packet processing logic 116 is configured to respond to control packets received on the links to which processing subsystem 100 is coupled, to generate control packets in response to processor cores 112 and/or cache memory subsystems 114, and to generate probe commands and response packets in response to transactions selected by memory controller 120 for service. Interface logic 140 may include logic to receive packets and synchronize the packets to an internal clock used by packet processing logic 116.

Additionally, processing subsystem 100 may include interface logic 140 used to communicate with other subsystems. Processing subsystem 100 may be coupled to communicate with an input/output (I/O) device (not shown) via interface logic 140. Such an I/O device may be further coupled to a second I/O device. Alternatively, a processing subsystem 100 may communicate with an I/O bridge, which is coupled to an I/O bus.

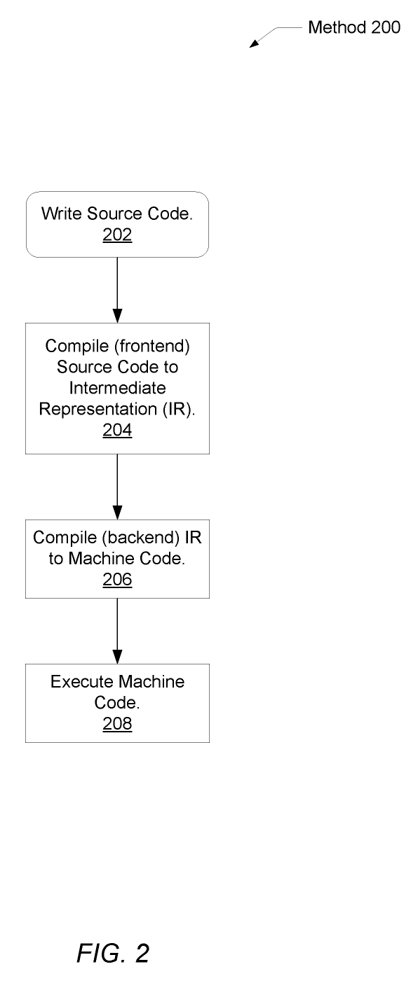

Referring to FIG. 2, one embodiment of a static compiler method 200 is shown. Software applications and subroutines may be written by a designer in a high-level language such as C, C++, Fortran, or other in block 202. Alternatively, microcode may be written by the designer. This source code may be stored on a computer readable medium. A command instruction, which may be entered at a prompt by a user, with any necessary options may be executed in order to compile the source code.

In block 204, the front-end compilation translates the source code to an intermediate representation (IR). Syntactic and semantic processing as well as some optimizations are performed at this step. The translation to an IR instead of bytecode, in addition to no use of a virtual machine, allows the source code to be optimized for performance on a particular hardware platform, rather than to be optimized for portability across different computer architectures.

The back-end compilation in block 206 translates the IR to machine code. The back-end may perform more transformations and optimizations for a particular computer architecture and processor design. For example, a processor is designed to execute instructions of a particular instruction set architecture (ISA), but the processor may have one or more processor cores. The manner in which a software application is executed (block 208) in order to reach peak performance may differ greatly between a single-, dual-, or quad-core processor. Other designs may have eight cores. Regardless, the manner in which to compile the software application in order to achieve peak performance may need to vary between a single-core and a multi-core processor.

One optimization that may be performed at this step is architectural register liveness analysis. Additionally, the code may be rewritten to reduce the usage of architectural registers based on the resulting register liveness information. Also, a control flow graph (CFG) may be generated by the compiler or a static analyzer tool. Control blocks form a control flow graph. A control block (CB) may refer to a basic block consisting of one or more code statements terminated by an unconditional jump instruction. Each control block may include the following information: a pointer to a list of instructions in the CB, a list of outflows, or exit paths, to other CBs; a list of inflows, input paths, from other CBs; and an indication whether the CB represents an exit-point-control-block, an entry-point-control-block, or neither.

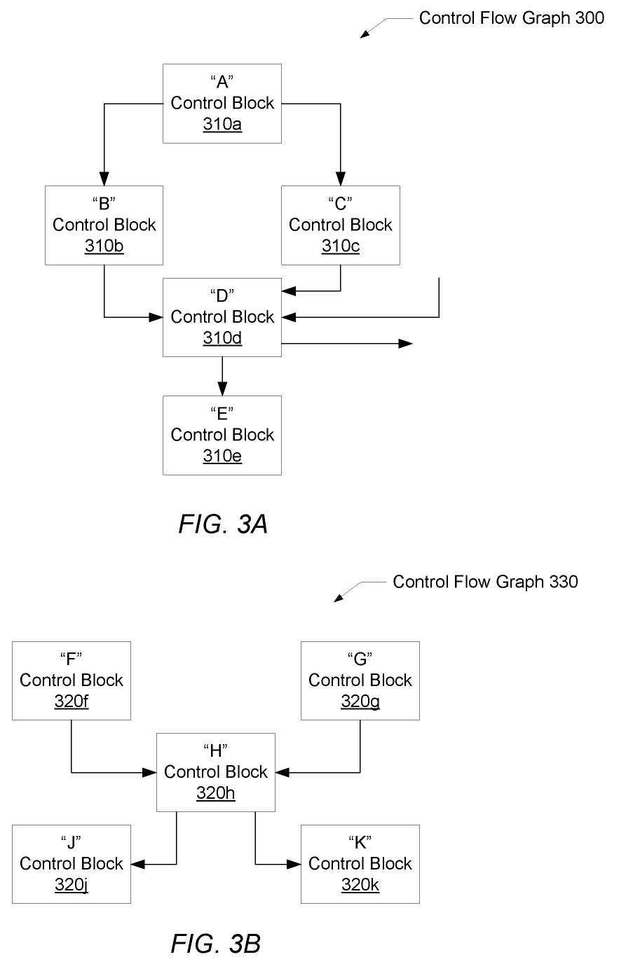

Referring to FIG. 3A and FIG. 3B, embodiments of a control flow graphs 300 and 330 are shown. Blocks 310 and 320 represent control blocks within a software application or a subroutine. The arrows represent paths. Control flow graphs 300 and 330 may represent complete graphs or a section of a larger control flow graph. Control block 310a, or A for simpler demonstration, may represent an entry-point-control-block. Control block 310e, or E for simpler demonstration, may represent an exit-point-control-block. Alternatively, control blocks A and E may connect to other control blocks not shown and the entry-point-control-block(s) and exit-point-control-block(s) are located elsewhere in a larger control flow graph.

One path within control flow graph (CFG) 300 may be represented by control blocks (CBs) A, B, D, and E. Paths are listed in program sequence order. A second path may be represented by CBs A, C, D, and E. One or more other paths may enter control block D via the shown inflow arrow and either end at control block E or another CB not shown through the shown outflow arrow.

Control flow graph 330 may have multiple entry-point-control-blocks such as control blocks F and G. Likewise, control blocks C and D may represent multiple exit-point-control-blocks. It is noted that a path comprising control blocks F, H, and K may not exist. This path may be a false path. Depending on the source code, CFG 330 may comprise two to four paths. For example, if CFG 330 only has two paths, the two paths may be control blocks F, H, and J; and control blocks G, H, and K. Then the false paths would be control blocks F, H, and K; and control blocks G, H, and J. A lack of context sensitivity may lead to an algorithm to not recognize the false paths.

In order to alleviate the context-sensitivity problem, which subsequently may reduce the value of register liveness information generated by an algorithm, information from the CFG builder may be used. For example, the CFG builder may be configured to generate required paths (RP). A required path can only be attached to outflows, and consist of a list of CBs that must have been visited in program sequence order prior to that path being valid.

Referring again to FIG. 3B, and assuming again CFG 330 only has two paths, the path H to J has a RP of F to H. The path H to K has an RP of G to H. Since CFG generation is a top-down algorithm, generating these paths is not difficult. To achieve maximum accuracy, pointer analysis should be done on indirect jumps when possible. This would involve searching for writes to the register used in the indirect jump and once found, generating the outflow with a RP from the write to the jump.

Before applying the use of required paths to a register liveness analysis algorithm, a traditional analysis algorithm is provided shortly. Control blocks and control flow graphs may be used in an analysis algorithm. Also, liveness vectors (LVs) may be utilized. In one embodiment, an LV is a bit vector wherein a bit represents the liveness of a corresponding architectural register. In one embodiment, a logic “1” indicates the corresponding register is live, and a logic “0” indicates the corresponding register is dead. A LV may be associated with each instruction in a program code to be analyzed. An LV may be determined to be accurate immediately before that instruction executes. An example of a traditional register liveness analysis bottom-up algorithm is shown in the following:

| | |
|---|---|
| GenLiveness ( ) { | /* line 4 */ |
| For each instruction I { I→LV=0; //All dead } | |
| For each control block CB { | |
| if (!CB → IsExitPoint) | |
| Continue; | |
| CalculateLivness (CB, 0); | |
| } | /* line 10 */ |
| } | |
| CalculateLiveness (CB, oldLV) { | |
| myLV=oldLV //Start with given LV | |
| for (i = CB → Numlnstructions; i >= 0; i−−) { | /* line 15 */ |
| myI = CB → Instructions(i); | |
| //Add previous information from this point | |
| myLV \|= myI → LV | |
| //Mark destination as dead, sources as live | |
| myLV &= ~(1 << myI → DestRegNum); | /* line 20 */ |
| myLV \|= (1 << m yI → SrcReg1); | |
| myLV \|= (1 << myI → SrcReg2); | |
| myI→ LV = myLV; | |
| } | |
| if (CB → lsEntryPoint) return; | /* line 25 */ |
| For each inflow FLOW to CB { | |
| CalculateLivness(FLOW → SrcCB, myLV); | |
| } | |
| } | /* line 29 */ |

The above algorithm is a bottom-up algorithm in that it starts from exit points, such as entry-point-control-blocks, and traverses up a control flow graph. The CalculateLiveness function takes two parameters. The first parameter is the CB to process, and the second parameter is the LV from the lower part of the tree. A binary OR operation is performed between the existing liveness information and the new information to handle the cases of conditional jumps. Conditional jumps are assumed to go either way since there is no context information used in this algorithm. As such, the liveness information from all the children must be included in the parent's LV. A register used by only one child cannot be replaced safely in the parent without possibly affecting execution

The above algorithm does not prevent repeat analysis of a control block when this control block is part of a recursive call or part of two or more paths with no change in program behavior above it. No new information will be provided by performing the repeated analysis, but computing resources are consumed nonetheless. Also, the above algorithm lacks context sensitivity, which may lead to analysis of false paths and contamination of propagated register liveness information. These problems may become more crucial when the algorithm is executed on microcode or any code that does not follow specific calling conventions.

The algorithm may be modified to include loop detection logic in order to prevent repeat liveness analysis due to recursive calls. Each time a call is performed for the CalculateLiveness function, such as line 13 above, the current CB may be recorded on a list, such as a stack, which may be passed to all subsequent calls. Before a CB calls itself recursively, a check is performed to determine whether this current CB has been analyzed immediately beforehand. The above algorithm may be modified by replacing line 13 above with line 30 below and adding line 31.

| | |
|---|---|
| CalculateLivness (CB, inputLV, path) { | /* line 30 */ |
| path→push_back(CB); | |

Also the above algorithm may be modified by replacing lines 25-28 above with lines 32-36 below.

| | |
|---|---|
| For each inflow FLOW to CB { | /* line 32 */ |
| if (!path→contains (FLOW→SrcCB)) | |
| CalculateLivness(FLOW→SrcCB, PLV); | |
| } | /* line 35 */ |
| path→pop_back( ); | |

Utilizing required paths from prior CFG generation, the above algorithm may be modified to eliminate context sensitivity problems. Later, it will be shown how the algorithm may be modified to use the resulting register liveness information to reduce architectural register usage and rewrite the code with less registers. First, two types of LVs may be maintained simultaneously. One type provides an LV to be associated with each instruction of program code. The second type provides an LV to be associated with the current path traversing the control flow graph from the bottom of the graph.

The first LV may be designated as a Master LV (MLV), which holds the final LV for its corresponding instruction. It consists of all information ever received about paths through the instruction. The second LV may be designated the Path LV (PLV) and may only contain information derived from the current path through the CFG. In the design, the MLV will be associated with the instruction, while the PLV will be used to propagate learned information up the CFG. The traditional algorithm shown above may have lines 14-24 replaced with lines 37-48 below.

| | |
|---|---|
| PLV = inputLV; | /* line 37 */ |
| for (i = CB→NumInstructions; b >= 0; i−−) { | |
| rnyI = CB→Instructions(i); | |
| MLV = rnyI→LV \| inputLV; | /* line 40 */ |
| PLV &= ~(1 << rnyI→DestRegNum); | |
| MLV &= ~(1 << rnyI→DestRegNum); | |
| PLV \|= (1 << rnyI→SrcReg1); | |
| MLV \|= (1 << rnyI→SrcReg2); | |
| PLV \|= (1 << rnyI→SrcReg2); | |
| MLV \|= (1 << rnyI→SrcReg2); | /* line 45 */ |
| myI→LV=MLV; | |
| inputLV = MLV; | |
| } | /* line 48 */ |

Now required paths from prior CFG generation may be used. Required paths are attached to outflows. The maintained list of paths of CBs used for loop detection may also be used to determine the particular outflow associated with the current CB and the previous CB. Referring again to FIG. 3B, if analysis has completed on control block J, then control block J has been pushed onto the list of paths, which may be implemented as a stack, and the algorithm has progressed to process control block H. Now a check is performed to determine the previous CB analyzed. In this case it is control block J. The outflows from control block H may be searched to determine that the path from H to J has a required path of control block F since in the source code the path H to J may only be valid if the code in control block F was executed first and not the code in control block G.

On a side note, another reason to search the outflows from control block H may be to determine which line of code within control block H to begin register liveness analysis, since it may not be the last instruction (bottom-up algorithm). Two other functions may be used in modifying the algorithm to utilize required paths to eliminate context sensitivity problems. The first function determines the type of flow of the path from the previous CB to the current CB. For example, it may be determined that this path is a required path. Then this path may be added to the given list. Several paths may be present so all must be added to the given list. One example of a possible function call may be given as OnRequiredPath (curCB, lastCB, list<paths>). The implementation is CFG specific, and, therefore, a detailed implementation is not given here. However, the function call is shown in further algorithm modifications provided later.

The second function determines at what line of code to start processing the current CB. The function searches the current CB for the first path from the bottom to the previous CB and returns an instruction index. One example of a possible function call may be given as FindEntryIndex (curCB, lastCB). Again, the implementation is CFG specific, and, therefore, a detailed implementation is not given here. However, the function call is shown in further algorithm modifications provided later.

Before further modifications of the algorithm are shown, the concept of a force path (FP) is now introduced. The force path is a list, which may be implemented as a stack, which may contain all the CBs to be visited after processing the current CB. A force path is needed for required paths, as only a specified CB should be visited, and not all the inflows. For example,

| | |
|---|---|
| CalculateLivness(CB, inputLV, path, FP) { | /* line 49 */ |
| lastCB = path→back( ); | |
| path→push-back(CB); | |
| OnRequiredPath (CB, lastCB, ReqPaths); | |
| PLV = inputLV; | |
| for (i=FindEntrylndex(CB, lastCB); i >= 0; i−−) { | |
| . . . | /* line 55 */ |
| } | |
| if (!FP→empty( )) { | |
| nextCB = FP→top( ); | |
| FP→pop( ); | |
| CalculateLiveness (nextCB, PLV, path, FP); | /* line 60 */ |
| } | |
| else if (!ReqPaths→empty( )) { | |
| For each ReqP in ReqPaths { | |
| For (myCB = ReqP.Start( ); | |
| myCB != ReqP.End( ); | |
| myCB = m yCB→Next) { | /* line 65 */ |
| FP→push(myCB); | |
| } | |
| nextCB = FP→top( ); | |
| FP→pop( ); | /* line 70 */ |
| CalculateLiveness (nextCB, PLV, path, FP); | |
| } | |
| } | |
| else { | |
| . . . // process inflows | |
| } | /* line 75 */ |
| } | |

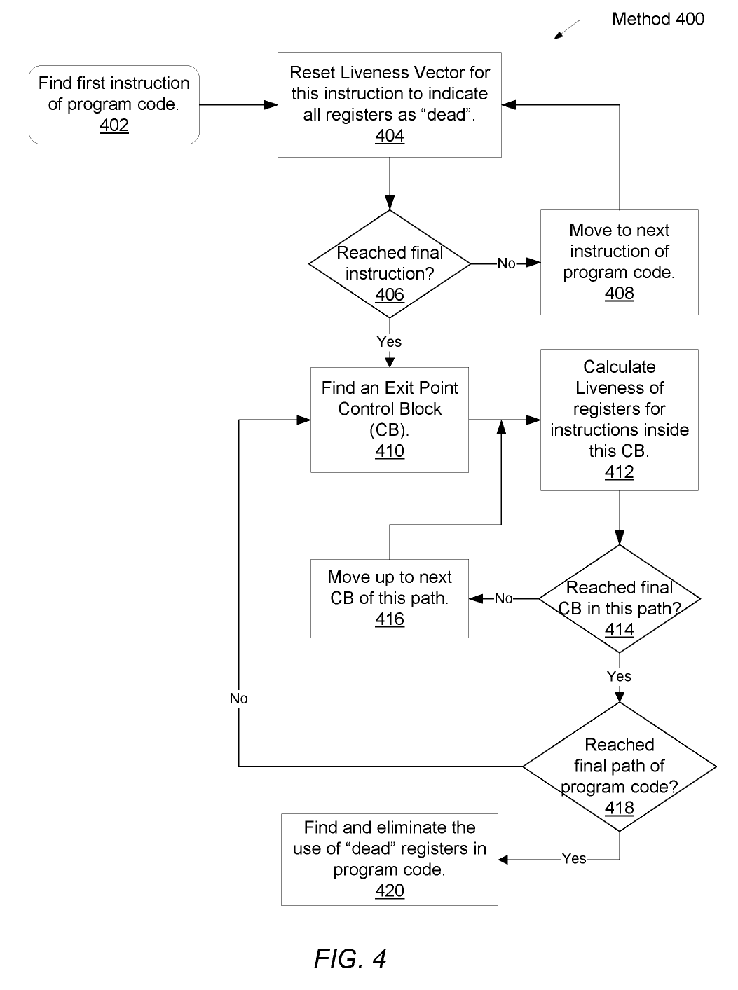

The algorithm above demonstrated in the pseudocode may be generalized in a method. Turning now to FIG. 4, one embodiment of a method 400 for register liveness analysis and register usage reduction is shown. For purposes of discussion, the steps in this embodiment and subsequent embodiments of methods described later are shown in sequential order. However, some steps may occur in a different order than shown, some steps may be performed concurrently, some steps may be combined with other steps, and some steps may be absent in another embodiment.

In block 402, the software program or subroutine to be analyzed is located. As used herein, program code may refer to an entire software program or a subroutine to be used in other programs. A pathname may be entered at a command prompt by a user, a pathname may be read from a predetermined directory location, or other. The program code may be written by a designer in a high-level language such as C, C++, Fortran, or other, or in microcode. In one embodiment, an assumption is made that the program code being analyzed runs standalone, or it does not interact with external code. This assumption causes exit points within the program code to have no liveness (all registers are dead).

In one embodiment, a representation of the liveness of architectural registers before an instruction executes is represented as a bit vector, or a liveness vector (LV) as described earlier. For the initial instruction in the program code, its corresponding LV is set to indicate all architectural registers are dead. In one embodiment, such an indication is provided by resetting all bits in the LV to a logic 0 value.

The control path including blocks 406, 408, and a return path to 404 resets a corresponding LV for each instruction in the program code. Once the final instruction is reached in conditional block 406, control blocks (CBs) and a control flow graph (CFG) from an existing earlier compiler stage may be used to perform the register liveness analysis. Paths and required paths may be provided in a top-down approach. For example, referring to FIG. 3A again, a path may be specified as A-B-D-E versus E-D-B-A. In one embodiment, method 400 uses a bottom-up approach. Exit-point-control-blocks may be identified and a particular one is chosen in block 410 to begin ascending a path. For example, in FIG. 3A, control block E may be chosen if the CFG 300 represents a complete CFG. In FIG. 3B, if CFG 330 is a complete CFG, rather than a subset CFG, then either control block J or K may be initially chosen.

An instruction within the exit-point-control-block is chosen as a starting point, since the last instruction may not always be the initial instruction for processing the corresponding control block. In one embodiment, a subroutine, or function, such as FindEntryIndex( ) described earlier may be used. Each time a control block is to be processed, an inspection may be needed to determine which control block is the present CB and which control block is the previous CB. Then the corresponding initial instruction may be located within the current CB to begin register liveness analysis.

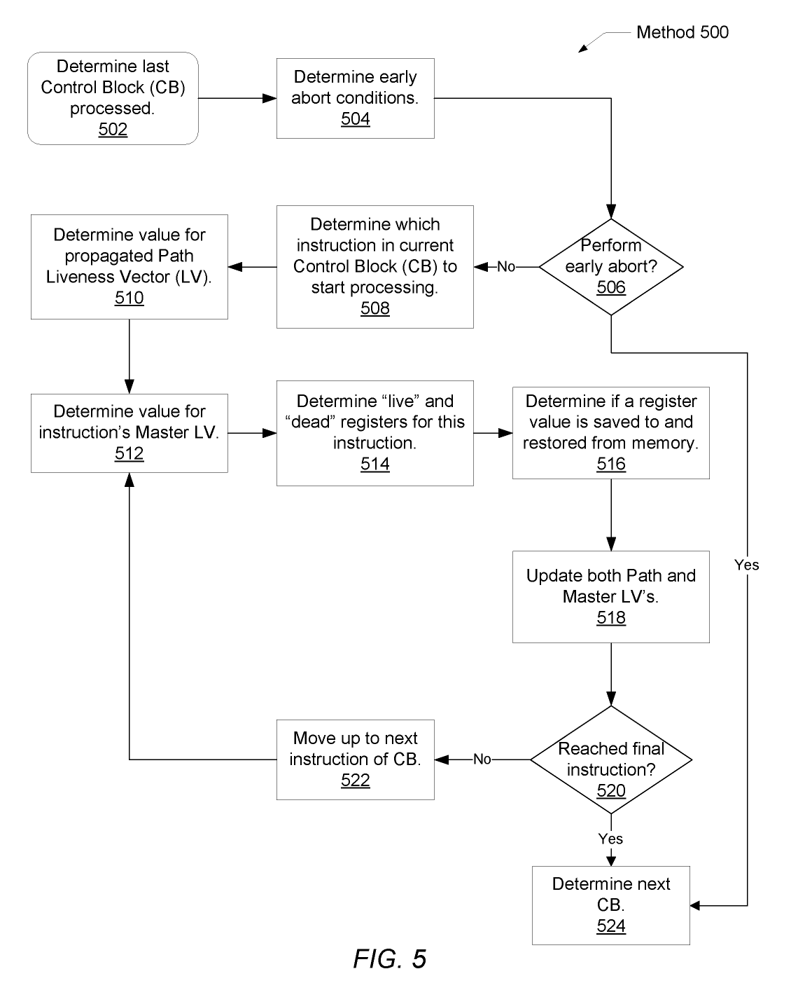

The liveness of the architectural registers for the initial instruction is determined in block 412. Details of this process is described later regarding a method in FIG. 5. Also, the above pseudo code provides steps of the process, such as in lines 53-56 in the above pseudocode, and will be referred to in the later description. Each instruction within the current control block above the initial instruction is successively processed in a bottom-up approach. Once the MLV for each instruction is updated and the PLV for Is this path is updated for the current CB, control flow of method 400 moves to conditional block 414.

If the current CB is not the final CB of the current path (conditional block 414), then the next control block in the bottom-up approach is determined in block 416. For example, in one embodiment, the if-elseif-else construct in lines 57, 62, and 73 of the above pseudo code may be utilized. This construct determines, first, the case when the analysis is already on a forced path. In this particular case, the choice of a next CB to process has already been determined to be a force path of a particular required path from earlier processing. In one embodiment, the next CB may be popped from a stack and analysis continues with that particular CB. Otherwise, it is determined whether to create a forced path due to the existence of a required path. If there is no present force path or required path, then each inflow CB to the current CB is processed one at a time.

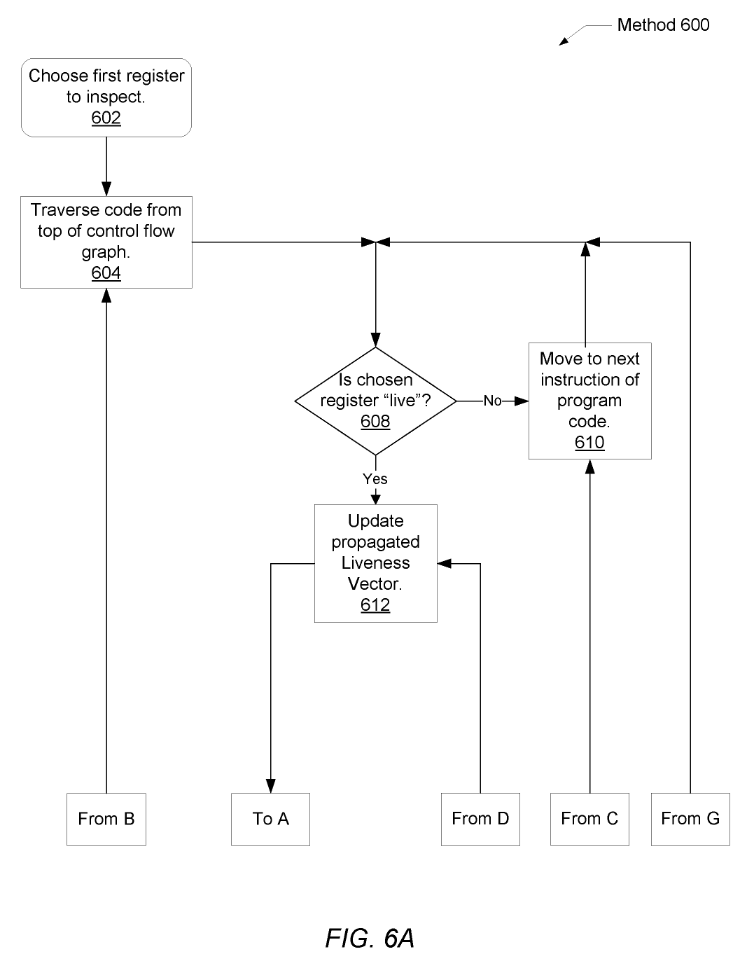

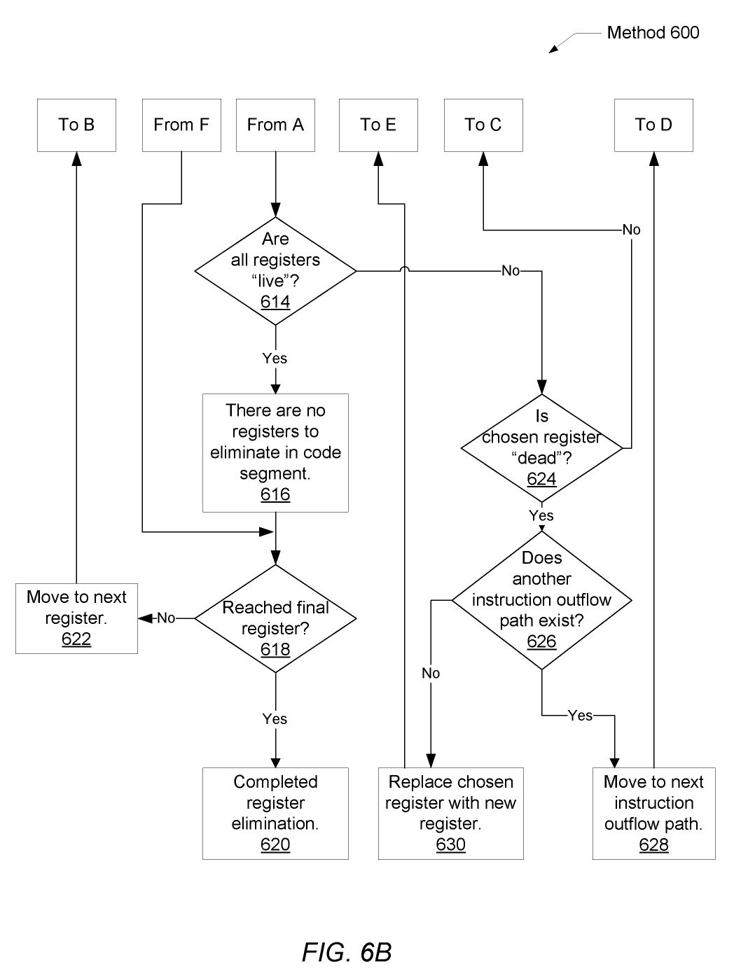

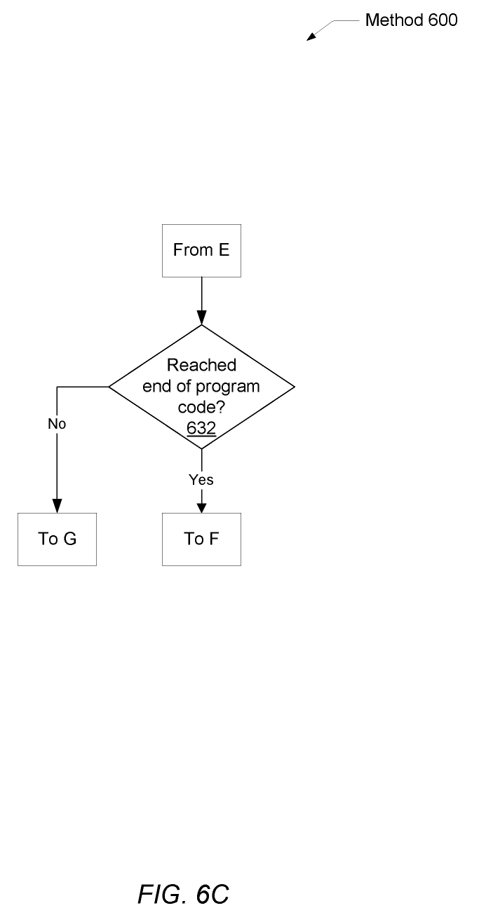

Once a next CB is determined in block 416, control flow of method 400 returns to block 412. When a final CB of the current path has been processed (conditional block 414), a determination is made as to whether the final path of the program code has been processed (conditional block 418). If not, then control flow of method 400 returns to block 410. Otherwise, control flow moves to block 420 where architectural register usage may be reduced. Details are provided later regarding FIG. 6.

Referring to FIG. 5, a method 500 for determining architectural register liveness within a CB is shown. Similar to method 400, the steps in this embodiment and subsequent embodiments of methods described later are shown in sequential order. However, some steps may occur in a different order than shown, some steps may be performed concurrently, some steps may be combined with other steps, and some steps may be absent in another embodiment.

In block 502, the previous CB to be processed is determined. In one embodiment, a simple stack may be used for this determination. This information aids in a later determinations regarding force paths and required paths. In block 504, early abort conditions may be tested in order to reduce execution time, hardware, and clock cycle usage by preventing repeat processing without yielding new information from occurring. One example is recognizing a recursive call within a CB.

Another example is to impose an early abort condition if all of the following are true: MLV==myI [symbol] LV, MLV!=0, FP [symbol] Empty( ), and ReqPaths [symbol] Empty( ). Essentially, these conditions may determine if no new information was learned, there is no force path, and the current path including the previous CB and the current CB does not have a required path.

In the case where code segments may exist in multiple CB's, an additional condition may be needed that checks if this particular code segment has been already processed in this current CB. This check may be needed since each CB may not have all the paths for that instruction. Variations of abort conditions are possible and contemplated.

If an early abort condition is determined to be true (conditional block 506), then control flow for method 500 moves to block 524. At block 524, a determination is made for the next CB. This determination may include the logic described regarding the earlier description of block 416 of FIG. 4.

If no early abort condition is not found to be true (conditional block 506), then control flow of method 500 moves to block 508 wherein a determination is made regarding which instruction within the current CB to begin processing. Processing may be path dependent and the bottom-up processing may not always begin at the last instruction within the current CB. In one embodiment, the earlier described function FindEntryIndex( ), also listed at line 54 in the above pseudo code may be used.

In one embodiment, two liveness vectors (LVs) may be maintained during processing, such as a Master LV (MLV) for each instruction and a Path LV (PLV) for each path. In blocks 510 and 512, initial values for these LVs are determined. For example, lines 40 and 53 in the above pseudo code may be used to update these values. The initial value of the MLV is the value present for its corresponding instruction after possible prior processing. The initial value of the PLV of the current CB may be the final value of the PLV of the previous CB. In block 514, registers may be determined to be live or dead based on the current instruction. The destination register of the current instruction may be determined to now be dead. The source registers of the current instruction may be determined to now be live.

In block 516, a check determines whether a register value is saved to and restored from memory within a CB. Subroutines which save to and restore register values from memory in order to ease register pressure may cause incorrect liveness of the register. Referring to FIG. 3B again, in one example, an instruction's operation within control block F may assign a data value to a register, such as R1. Within control block H, a first instruction's operation may store the contents of R1 to system memory, which may be placed in a cache memory subsystem. A second instruction's operation may restore these contents from memory and place them in R1 again. Therefore, between the first and second instructions, R1 may be used to replace another architectural register. Within control block J, an instruction's operation may use R1 as a source register. In this example, R1 may not be used by instructions within control blocks G and K.

The path F-H-J uses R1 and therefore R1 must be live throughout except for the lines of code between the first and the second instructions within control block H. The path G-H-K does not use R1. Therefore by inspection, R1 should be live in F and J, and dead in G and K. Furthermore, R1 should be live within control block H before the save to memory in the first instruction, and after the restore from memory in the second instruction. Without corrective action in block 516, the method 500 may not produce this result since the store of R1 to memory appears to be a usage of R1.

Along the J-H path, R1 is live. R1 is marked as live, such as a corresponding set bit in its LV, at the end of control block H, at the beginning of H, and in F. Along the K-H path however, R1 is dead. Therefore, in one embodiment, an entry may be created in a table with register number 1 and the corresponding address of the memory store operation. At the top of control block H, the method looks for an entry in the table. The entry is found since R1 is being stored in the first instruction. Note that it is irrelevant if any memory write operations to this same address occurred earlier. Upon finding the table entry, register R1 is marked as dead, and this data propagates up to G, in order that R1 is dead at control block G. This achieves the correct result.

The corresponding bits within the MLV and the PLV are updated in block 518. For example, lines 41-45 of the above pseudo code demonstrate one embodiment of an update of these values. If the final instruction of the current CB has not been processed (conditional block 520), then the next instruction to process in the bottom-up approach may be determined to be the prior instruction in program order in block 522. Then control flow of method 500 returns to block 512. Otherwise, if the final instruction within the current CB has been processed (conditional block 520), then control flow moves to block 524 and the next CB to process is determined as described earlier regarding block 524 and block 416.

Turning now to FIG. 6A-6C, one embodiment of a method 600 for determining and eliminating dead registers from program code is shown. Similar to method 500, the steps in this embodiment and subsequent embodiments of methods described later are shown in sequential order. However, some steps may occur in a different order than shown, some steps may be performed concurrently, some steps may be combined with other steps, and some steps may be absent in another embodiment.

Once register liveness analysis is complete as described in methods 400 and 500, method 600 may be used to determine registers to eliminate from segments of program code. Method 600 corresponds to block 420 of method 400 in FIG. 4. One of the architectural registers is chosen for inspection in block 602. In one embodiment, the highest numbered register may be initially chosen and for each iteration of processing, the register number may be decremented to determine the next chosen register. Alternatively, the lowest numbered register may be initially chosen and for each iteration of processing, the register number may be incremented to determine the next chosen register. Other embodiments are possible and contemplated.

The program code is traversed beginning at the top of the CFG in block 604. If the chosen register is not live for the current instruction (conditional block 608), then the next sequential instruction is considered in block 610 and control flow returns to conditional block 608. If the chosen register is live for the current instruction (conditional block 608), then this instruction may be recorded, such as its address, for a possible starting point of other possible instruction outflow paths. Also, a propagated result liveness vector (RLV) is updated in block 612. In one embodiment, the RLV is a bit vector similar to the PLV with a single bit corresponding for each architectural register. For example, if there are 32 architectural registers in an architecture, then there are 32 bits in the bit vector RLV. In one embodiment, the initial value of the RLV is the value of the MLV of this first instruction found with a live value for the chosen register. In one embodiment, the RLV may be logically OR'ed with the MLV of the current instruction. Basically, each architectural register that is indicated as live, such as within the MLV, for the corresponding instruction has this indication updated in the RLV.

If all registers are live (conditional block 614), then in block 616 there are no registers to eliminate in this code segment beginning with the determined first instruction from conditional block 608. If the final register of the architectural registers has been processed (conditional block 618), then the register elimination method has completed in block 620. Otherwise, if the final register of the architectural registers has been processed (conditional block 618), then the next register is chosen to be processed in block 622. In one embodiment, the next sequential register may be chosen whether this next sequential register is found by incrementing or decrementing by one. Control flow of method 600 returns to block 604.

If all registers are not live (conditional block 614), then there may be registers to eliminate in this code segment beginning with the determined first instruction from conditional block 608. If the chosen register is not dead (conditional block 624), which on the first check the chosen register won't be dead, then the next instruction in the current path of the program code is selected in block 610. Later, if the chosen instruction is determined to be dead (conditional block 624), then a determination is made whether another outflow path exists from the first instruction determined in conditional block 608.

If no other outflow paths exist (conditional block 626), then the RLV may be inspected to determine which dead register may replace the chosen register within the selected code segment in block 630. For example, within the selected code segment, if R30 is the chosen register and R29 is one of the determined dead registers, then R30 may be replaced by R29. A table may be updated to indicate this replacement for later program code modification, or the program code may be directly modified now. Then R29 may become the next chosen register, and the process repeats to determine if any of the registers R0-R28 may replace R29. In one embodiment, some registers may be predetermined not to be candidates for replacing other registers or to be replaced due to specific requirements on their use.

Next control flow of method 600 moves from block 630 to conditional block 632. If the end of the program code has been reached (conditional block 632), then control flow of method 600 moves to conditional block 618. Otherwise, control flow returns to conditional block 608.

If another instruction outflow path does exist (conditional block 626), then the current value of the RLV may be used in the next path in block 628. The next existing instruction outflow is chosen and control flow of method 600 returns to block 612.

Various embodiments may further include receiving, sending or storing instructions and/or data that implement the above described functionality in accordance with the foregoing description upon a computer readable medium. Generally speaking, a computer readable storage medium may include one or more storage media or memory media such as magnetic or optical media, e.g., disk or CD-ROM, volatile or non-volatile media such as RAM (e.g., SDRAM, DDR SDRAM, RDRAM, SRAM, etc.), ROM, etc.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for architectural register allocation and liveness analysis, the method comprising:
determining a first register is live at a first instruction;
identifying one or more allocation code paths from the first instruction, wherein each allocation code path terminates at an instruction wherein the first register is determined to be dead for the first time in said allocation code path;
determining one or more registers are dead within an accumulative traversal of said allocation code paths; and
replacing the first register with a determined dead register.

2. The method as recited in claim 1, further comprising updating a single path indication for each analysis code path from an exit-point-control-block to a corresponding entry-point-control-block of a control flow graph.

3. The method as recited in claim 2, further comprising traversing a force path, wherein a force path includes an inflow control block (CB) of a current CB of an analysis code path only if the inflow CB is a required path of the current outflow CB of the current CB.

4. The method as recited in claim 1, further comprising updating a single result indication for said accumulative traversal, wherein the result indication comprises an indication for each architectural register whether the corresponding architectural register is live or dead before a corresponding instruction executes.

5. The method as recited in claim 4, further comprising maintaining a master indication for each instruction of program code, wherein the master indication comprises for each architectural register an indication whether the corresponding architectural register is live or dead before a corresponding instruction executes, further comprising for each instruction in said accumulative traversal, updating the result indication to indicate a live register when the result indication indicates a dead register and the master indication indicates a live register.

6. The method as recited in claim 3, further comprising updating the master and path indications to indicate an architectural register is dead in response to the corresponding instruction is a store operation to system memory, a second instruction later in program sequence within the current CB is a load from system memory, and said architectural register is dead corresponding to second instruction.

7. The method as recited in claim 6, further comprising updating the master indications if determining there is no early abort condition comprising at least one of the following: the current CB has been already traversed and there is no required paths for the current CB.

8. The method as recited in claim 5, wherein the initial value of the result indication is the final value of the master indication of the first instruction.

9. A computing system comprising:
one or more processors comprising one or more processor cores;
a memory coupled to the one or more processors; and
a compiler configured to:
determine a first register is live at a first instruction;
identify one or more allocation code paths from the first instruction, wherein each allocation code path terminates at an instruction wherein the first register is determined to be dead for the first time in said allocation code path;
determine one or more registers are dead within an accumulative traversal of said allocation code paths; and
replace the first register with a determined dead register.

10. The computing system as recited in claim 9, further comprising updating a single path indication for each analysis code path from an exit-point-control-block to a corresponding entry-point-control-block of a control flow graph.

11. The computing system as recited in claim 10, further comprising traversing a force path, wherein a force path includes an inflow control block (CB) of a current CB of an analysis code path only if the inflow CB is a required path of the current outflow CB of the current CB.

12. The computing system as recited in claim 9, further comprising updating a single result indication for said accumulative traversal, wherein the result indication comprises an indication for each architectural register whether the corresponding architectural register is live or dead before a corresponding instruction executes.

13. The computing system as recited in claim 12, further comprising maintaining a master indication for each instruction of program code, wherein the master indication comprises for each architectural register an indication whether the corresponding architectural register is live or dead before a corresponding instruction executes, further comprising for each instruction in said accumulative traversal, updating the result indication to indicate a live register when the result indication indicates a dead register and the master indication indicates a live register.

14. The computing system as recited in claim 11, further comprising updating the master and path indications to indicate an architectural register is dead in response to the corresponding instruction is a store operation to system memory, a second instruction later in program sequence within the current CB is a load from system memory, and said architectural register is dead corresponding to second instruction.

15. The computing system as recited in claim 14, further comprising updating the master indications if determining there is no early abort condition comprising at least one of the following: the current CB has been already traversed and there is no required paths for the current CB.

16. The computing system as recited in claim 13, wherein the initial value of the result indication is the final value of the master indication of the first instruction.

17. A computer readable storage medium storing program instructions operable to perform register liveness analysis and reduce register usage, wherein the program instructions are executable to:
determine a first register is live at a first instruction;
identify one or more allocation code paths from the first instruction, wherein each allocation code path terminates at an instruction wherein the first register is determined to be dead for the first time in said allocation code path;
determine one or more registers are dead within an accumulative traversal of said allocation code paths; and
replace the first register with a determined dead register.

18. The storage medium as recited in claim 17, further comprising updating a single path indication for each analysis code path from an exit-point-control-block to a corresponding entry-point-control-block of a control flow graph.

19. The storage medium as recited in claim 18, further comprising traversing a force path, wherein a force path includes an inflow control block (CB) of a current CB of an analysis code path only if the inflow CB is a required path of the current outflow CB of the current CB.

20. The storage medium as recited in claim 17, further comprising updating a single result indication for said accumulative traversal, wherein the result indication comprises an indication for each architectural register whether the corresponding architectural register is live or dead before a corresponding instruction executes.
